(19) United States
(12) Patent Application Publication
(10) Pub. No.: US 2019/0214854 A1
(43) Pub. Date: Jul. 11, 2019

(54) METHOD AND APPARATUS FOR CONTROLLING WIRELESS POWER RECEIVER INCLUDING NEAR FIELD COMMUNICATION ANTENNA

(71) Applicant: LG INNOTEK CO., LTD., Seoul (KR)

(72) Inventor: Sung Hyun LEEM, Seoul (KR)

(73) Assignee: LG INNOTEK CO., LTD., Seoul (KR)

(21) Appl. No.: 16/325,544

(22) PCT Filed: Aug. 16, 2017
(86) PCT No.: PCT/KR2017/008877

§ 371 Date: Feb. 14, 2019

(30) Foreign Application Priority Data
Sep. 8, 2016 (KR) 10-2016-0115531

(51) Int. Cl. H02J 50/20; H02J 50/80; H02J 7/02; H02J 50/12

(52) U.S. Cl. CPC H02J 50/20; H02J 50/80; H01Q 7/00; H02J 50/12; H02J 7/025

(57) ABSTRACT

The present invention relates to a method and an apparatus for controlling a wireless power receiver including a near field communication (NFC) antenna. A method for controlling a wireless power receiver including a near field communication antenna and a wireless power antenna according to one embodiment of the present invention comprises the steps of: sensing, by an NFC protection module, power generated from the near field communication antenna; blocking, by the NFC protection module, the power applied to an NFC control module when the magnitude of the power satisfies the blocking condition; and applying the blocked power to a wireless power control module, or discharging the blocked power, by the NFC protection module.

### TECHNICAL FIELD

Embodiments relate to a wireless power receiver, and more particularly, to a method and apparatus for controlling a wireless power receiver including a near field communication (NFC) antenna.

### BACKGROUND ART

A portable terminal such as a cellular phone and a laptop computer includes a battery for storing power and a circuit for charging and discharging the battery. To charge the battery of such a terminal, the terminal needs to receive power from an external charger.

In general, an example of an electrical connection mode between a battery and a charging device for charging the battery with power includes a terminal supply mode of receiving commercial power, converting the commercial power into voltage and current corresponding to the battery, and supplying electrical energy to the battery through a terminal of the corresponding battery. The terminal supply mode is accompanied by use of a physical cable or wiring. Accordingly, when many equipments of the terminal supply mode are used, a significant working space is occupied by many cables, it is difficult to organize the cables, and an outer appearance is achieved. In addition, the terminal supply mode causes problems such as an instantaneous discharge phenomenon due to different potential differences between terminals, damage and fire due to impurities, natural discharge, and degradation in lifespan and performance of a battery.

Recently, to overcome the problems, a charging system (hereinafter, referred to as a “wireless charging system”) and control methods using a mode of wirelessly transmitting power have been proposed. In the past, a wireless charging system is not basically installed in some terminals and a consumer needs to purchase a separate accessory of a wireless charging receiver and, thus, a demand for a wireless charging system is low, but users of wireless charging are expected to be remarkably increased and, in the future, a terminal manufacturer is also expected to basically installed a wireless charging function.

In general, a wireless charging system includes a wireless power transmitter that supplies energy electrical energy in a wireless power transmission mode and a wireless power receiver that receives electrical energy supplied from the wireless power transmitter and charges a battery with the electrical energy.

The wireless charging system may transmit power in at least one wireless power transmission mode (e.g., an electromagnetic induction mode, an electromagnetic resonance mode, and a radio frequency (RF) wireless power transmission mode).

For example, the wireless power transmission mode may use various wireless power transmission standards based on an electromagnetic induction mode for performing charging using an electromagnetic induction principle whereby a power transmission end coil generates a magnetic field to induce electricity in a reception end coil by the influence of the magnetic field. Here, the wireless power transmission standard of the electromagnetic induction mode may include a wireless charging technology of an electromagnetic induction mode in the wireless power consortium (WPC) and/or the power matters alliance (PMA).

As another example, the wireless power transmission mode may use an electromagnetic resonance mode for transmitting power to a wireless power receiver positioned at a short distance via synchronization between a magnetic field generated by a transmission coil of a wireless power transmitter and a specific resonance frequency. Here, the electromagnetic resonance mode may include a wireless charging technology defined in the alliance for the wireless power (A4WP) standard institute that is a wireless charging technology standard institute.

As another example, the wireless power transmission mode may use an RF wireless power transmission mode for transmitting power to a wireless power receiver positioned at a long distance by delivering low power energy in an RF signal.

Korean Patent Application No. 10-2013-7033209 (Receiver for Wireless Power Reception and Wireless Power Receiving Method thereof) discloses a receiver for a wireless charging system including a coil for receiving power energy and a near field communication (NFC) that is separately configured outside the coil.

In a wireless charging receiver including an NFC coil, an electromagnetic field or an RF signal that is generated from a wireless power transmitter for wireless power transmission generates power (current or voltage) in an adjacent NFC coil, and when power generated in the NFC coil is greater than rated voltage of an NFC control circuit, there is a problem in that the NFC control circuit is damaged.

Accordingly, when the NFC coil and a transmission/reception coil for wireless power are arranged adjacently to each other, there is a need for a method of protecting an NFC control circuit.

### DISCLOSURE

### Technical Problem

Embodiments provide a method and apparatus for controlling a wireless power receiver including a near field communication (NFC) antenna.

Further, embodiments provide a method and apparatus for protecting an NFC control device from overcurrent or overvoltage generated in an NFC antenna according to a magnetic field or a radio frequency (RF) signal for wireless power transmission when the NFC antenna and a wireless power antenna are disposed adjacently to each other.

It is to be understood that both the foregoing general description and the following detailed description of the present disclosure are exemplary and explanatory and are intended to provide further explanation of the present disclosure as claimed.

### Technical Solution

In one embodiment, a method of controlling a wireless power receiver including a near field communication (NFC) antenna and a wireless power antenna includes detecting power generated from the NFC antenna by an NFC protection module, when amplitude of the power satisfies a block condition, blocking power supplied to the NFC control module, by the NFC protection module, and supplying the blocked power to the wireless power control module or discharging the power, by the NFC protection module.

In some embodiments, the detecting of the power includes detecting intensity of current generated from the NFC antenna.

In some embodiments, the block condition may be satisfied when the intensity of the current is greater than a first threshold value.

In some embodiments, the method may further include receiving a block signal about whether power from the wireless power control module is blocked, by the NFC protection module.

In some embodiments, the method may further include receiving charging state information from the wireless power control module to determine whether power is blocked, by the NFC protection module.

In some embodiments, the NFC antenna may be disposed adjacently to the wireless power antenna.

In some embodiments, the supplying the blocked power to the wireless power control module or discharging, by the NFC protection module may include supplying the current to the wireless power control module when the intensity of the current is less than a second threshold value.

In some embodiments, the supplying the blocked power to the wireless power control module or discharging, by the NFC protection module may include discharging the current when the intensity of the current is greater than the second threshold value.

In some embodiments, the supplying the blocked power to the wireless power control module or discharging, by the NFC protection module may include supplying the current to the wireless power antenna or supplying the current to a wireless power rectifier configured to receive current from the wireless power antenna.

In some embodiments, the detecting of the power includes detecting intensity of voltage generated from the NFC antenna.

In some embodiments, the block condition may be satisfied when the intensity of the voltage is greater than a first threshold value.

In some embodiments, the supplying the blocked power to the wireless power control module or discharging, by the NFC protection module may include applying the voltage to the wireless power control module when the intensity of the voltage is less than a second threshold value.

In some embodiments, the supplying the blocked power to the wireless power control module or discharging, by the NFC protection module may include discharging the voltage when the intensity of the voltage is greater than a second threshold value.

In some embodiments, the supplying the blocked power to the wireless power control module or discharging, by the NFC protection module may include applying the voltage to the wireless power antenna or applying the voltage to a wireless power rectifier configured to receive a voltage from the wireless power antenna.

In another embodiment, a computer readable recording medium has recorded thereon a program for executing the methods of controlling a wireless power receiver.

In another embodiment, a wireless power receiver includes an near field communication (NFC) antenna, and an NFC protection module configured to detect power generated from the NFC antenna, to block power supplied to the NFC control module when amplitude of the power satisfies a block condition, and to supply the blocked power to the wireless power control module or to discharge the power.

In some embodiments, the NFC protection module may include a monitoring unit configured to detect intensity of current generated from the NFC antenna.

In some embodiments, the block condition may be satisfied when the intensity of the current is greater than a first threshold value.

In some embodiments, the NFC protection module may include a communication unit configured to receiver about whether power from the wireless power control module is blocked.

In some embodiments, the NFC protection module may include a controller configured to receive charging state information from the wireless power control module to determine whether power is blocked.

In some embodiments, the NFC antenna may be disposed adjacently to the wireless power antenna.

In some embodiments, the NFC protection module may include a switching unit configured to supply the current to the wireless power control module when the intensity of the current is less than a second threshold value, and the second threshold value may have a value greater than the first threshold value.

In some embodiments, the NFC protection module may include a switching unit configured to discharge the current when the intensity of the current is greater than the second threshold value.

In some embodiments, the NFC protection module may include a switching unit configured to supply the current to the wireless power antenna or to supply the current to a wireless power rectifier configured to receive current from the wireless power antenna.

In some embodiments, the NFC protection module may include a monitoring unit configured to detect intensity of the voltage generated from the NFC antenna.

In some embodiments, the block condition may be satisfied when the intensity of the voltage is greater than a first threshold value.

In some embodiments, the NFC protection module may include a switching unit configured to apply the voltage to the wireless power control module when the intensity of the voltage is less than the second threshold value, and the second threshold value may have a value greater than the first threshold value.

In some embodiments, the NFC protection module may include a switching unit configured to discharge the voltage when the intensity of the voltage is greater than the second threshold value.

In some embodiments, the NFC protection module may include a switching unit configured to apply the voltage to the wireless power antenna or to apply the voltage to a wireless power rectifier configured to receive a voltage from the wireless power antenna.

In another embodiment, an NFC protection device includes a monitoring unit configured to detect intensity of power generated from an NFC antenna, a controller configured to block power supplied to an NFC control module when amplitude of the power satisfies a block condition; and a switching unit configured to supply the blocked power to the wireless power control module, or to discharge the power, by the NFC protection module, wherein the NFC antenna is disposed adjacently to the wireless power antenna.

In some embodiments, the monitoring unit may detect intensity of current generated from an NFC antenna.

In some embodiments, the block condition may be satisfied when the intensity of the current is greater than a first threshold value.

In some embodiments, the NFC protection device may further include a communication configured to receive a block signal about whether power is blocked, from the wireless power control module.

In some embodiments, the controller may receive charging state information from the wireless power control module to determine whether power is blocked.

In some embodiments, the NFC antenna may be disposed adjacently to the wireless power antenna.

In some embodiments, the switching unit may supply the current to the wireless power control module when intensity of the current is less than a second threshold value, and the second threshold value may have a value greater than the first threshold value.

In some embodiments, the switching unit may discharge the current when the intensity of the current is greater than the second threshold value.

In some embodiments, the switching unit may supply the current to the wireless power antenna or may supply the current to a wireless power rectifier configured to receive current from the wireless power antenna.

In some embodiments, the monitoring unit may detect the intensity of the voltage generated from the NFC antenna.

In some embodiments, the block condition may be satisfied when the intensity of the voltage is greater than a first threshold value.

In some embodiments, the switching unit may apply the voltage to the wireless power control module when intensity of the voltage is less than a second threshold value, and the second threshold value may have a value greater than the first threshold value.

In some embodiments, the switching unit may discharge the voltage when the intensity of the voltage is greater than the second threshold value.

In some embodiments, the switching unit may apply the voltage to the wireless power antenna or may apply the voltage to a wireless power rectifier configured to receive a voltage from the wireless power antenna.

It is to be understood that both the foregoing general description and the following detailed description of the present disclosure are exemplary and explanatory and are intended to provide further explanation of the present disclosure as claimed.

### Advantageous Effects

A method and apparatus for controlling a wireless power receiver including a near field communication (NFC) antenna according to embodiments of the present disclosure may have the following effects.

First, the embodiments of the present disclosure may prevent an NFC chip from being damaged by power adsorbed to the NFC antenna.

Second, the embodiments of the present disclosure may supply power adsorbed to the NFC antenna to a wireless power receiver to increase charging efficiency.

It will be appreciated by persons skilled in the art that that the effects that could be achieved with the present disclosure are not limited to what has been particularly described hereinabove and other advantages of the present disclosure will be more clearly understood from the following detailed description taken in conjunction with the accompanying drawings.

### DESCRIPTION OF DRAWINGS

Arrangements and embodiments may be described in detail with reference to the following drawings in which like reference numerals refer to like elements and wherein:

FIG. 1 is a block diagram for explanation of a wireless charging system according to an embodiment;

FIG. 2 is a block diagram for explanation of a wireless charging system according to another embodiment;

FIG. 3 is a state transition diagram for explanation of a wireless power transmission procedure defined in the wireless power consortium (WPC) standard;

FIG. 4 is a state transition diagram for explanation of a wireless power transmission procedure defined in the power matters alliance (PMA) standard;

FIG. 5 is a block diagram for explanation of a structure of a wireless power transmission system according to an embodiment;

FIG. 6 is an equivalent circuit diagram of a wireless power transmission system according to an embodiment;

FIG. 7 is a state transition diagram for explanation of a state transition procedure of a wireless power transmitter using an electromagnetic resonance mode according to an embodiment;

FIG. 8 is a state transition diagram of a wireless power receiver using an electromagnetic resonance mode according to an embodiment;

FIG. 9 is a flowchart for explanation of a wireless charging procedure using an electromagnetic resonance mode according to an embodiment;

FIGS. 10A, 10B, and 10C are diagrams for explanation of an NFC antenna that is disposed adjacently to a wireless charging coil according to an embodiment;

FIG. 11 is a diagram for explanation of the configuration of a wireless power receiver including a near field communication (NFC) antenna according to an embodiment;

FIG. 12 is a diagram for explanation of power transfer of an NFC protection module according to an embodiment;

FIG. 13 is a diagram for explanation of the configuration of an NFC protection device according to an embodiment; and

FIG. 14 is a diagram for explanation of a control method for protecting an NFC control module according to an embodiment.

### BEST MODE

A method of controlling a wireless power receiver including a near field communication (NFC) antenna and a wireless power antenna includes detecting power generated from the NFC antenna by an NFC protection module, when amplitude of the power satisfies a block condition, blocking power supplied to the NFC control module, by the NFC protection module, and supplying the blocked power to the wireless power control module or discharging the power, by the NFC protection module.

### MODE FOR INVENTION

Hereinafter, devices and various methods, to which embodiments of the present disclosure are applied, will be described in more detail with reference to the accompanying drawings. The suffixes “module” and “unit” of elements herein are used for convenience of description and thus can be used interchangeably and do not have any distinguishable meanings or functions.

Although all elements constituting the embodiments of the present disclosure are described as integrated into a single one or to be operated as a single one, the present disclosure is not necessarily limited to such embodiments. According to the present disclosure, all of the elements may be selectively integrated into one or more and be operated as one or more within the scope of the present disclosure. Each of the elements may be implemented as independent hardware. Alternatively, some or all of the elements may be selectively combined into a computer program having a program module performing some or all functions combined in one or more pieces of hardware. Code and code segments constituting the computer program may be easily understood by those skilled in the art to which the present disclosure pertains. The computer program may be stored in computer readable media such that the computer program is read and executed by a computer to implement the present disclosure. Computer program storage media may include magnetic recording media, optical recording media, and carrier wave media.

In description of exemplary embodiments, will be understood that, when an element is referred to as being “on” or “under” and “before” or “after” another element, the element can be directly on another element or intervening elements may be present.

The terms “comprises”, “includes”, and “has” described herein should be interpreted not to exclude other elements but to further include such other elements since the corresponding elements may be included unless mentioned otherwise. All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings in the related art from the context. Unless differently defined in the present disclosure, such terms should not be interpreted in an ideal or excessively formal manner.

It will be understood that, although the terms first, second, A, B, (a), (b), etc. may be used herein to describe various elements of the present disclosure, these terms are only used to distinguish one element from another element and essential, order, or sequence of corresponding elements are not limited by these terms. It will be understood that when one element is referred to as being “connected to”, “coupled to”, or “access” another element, one element may be “connected to”, “coupled to”, or “access” another element via a further element although one element may be directly connected to or directly access another element.

In the description of the present disclosure, certain detailed explanations of related art are omitted when it is deemed that they may unnecessarily obscure the essence of the present disclosure.

In the following description of the present disclosure, for convenience of description, an apparatus for wirelessly transmitting power in a wireless power charging system may be used interchangeably with a wireless power transmitter, a wireless power transmission apparatus, a wireless power transmission device, a transmission end, a transmitter, a transmission apparatus, a transmission side, a wireless charging apparatus, etc. In addition, for convenience of description, an apparatus for wirelessly receiving power from a wireless power transmission apparatus may be used interchangeably with a wireless power reception apparatus, a wireless power receiver, a wireless power reception device, a reception terminal, a reception side, a reception apparatus, a receiver terminal, etc.

A wireless charging apparatus according to the present disclosure may be configured in the form of a pad, a cradle, an access point (AP), a small base station, a stand, a ceiling insert type, a wall-hanging type, a vehicle insert type, a vehicle mount type, or the like. One transmitter may simultaneously transmit power to a plurality of wireless power reception apparatuses.

For example, a wireless power transmitter is generally put and used on a desk, a table, or the like and is also developed and applied to a vehicle and is used in the vehicle. A wireless power transmitter installed in a vehicle is provided in the form of a cradle to be simply and stably fixed and supported.

A terminal according to the present disclosure may be mounted on a small-size electronic apparatus such as a mobile phone, a smartphone, a laptop, a digital broadcasting terminal, a personal digital assistants (PDA), a portable multimedia player (PMP), a navigation system, an MP3 player, an electric toothbrush, a radio frequency identification (RFID) tag, an illumination apparatus, a remote controller, and a bobber, without being limited thereto. Accordingly, the terminal according to the present disclosure may be any mobile device (hereinafter, referred to as a “device”) that includes a wireless power reception element according to the present disclosure is installed therein and includes a rechargeable battery and may be interchangeably used with a terminal or a device. A wireless power receiver according to another embodiment may also be installed in a vehicle, an unmanned aerial vehicle, an AR. drone, a robot, and so on.

A wireless power receiver according to an embodiment may use at least one wireless power transmission mode and may also simultaneously and wirelessly receive power from two or more wireless power transmitters. Here, the wireless power transmission mode may include at least one of the electromagnetic induction mode, the electromagnetic resonance mode, and the RF wireless power transmission mode. In particular, a wireless power receiving feature for supporting an electromagnetic induction method may include a wireless charging technology of an electromagnetic induction method defined in wireless power consortium (WPC) and power matters alliance (PMA) that are wireless charging technology standard organizations.

In general, a wireless power transmitter and a wireless power receiver, which are included in a wireless power system, may exchange a control signal or information via in-band communication or Bluetooth low energy (BLE) communication. Here, in-band communication and BLE communication may be performed using a pulse width modulation mode, a frequency modulation mode, a phase modulation mode, an amplitude modulation mode, an amplitude and phase modulation mode, or the like. For example, the wireless power receiver may ON/OFF switch current induced through a reception coil in a predetermined pattern to generate a feedback signal and, thus, may transmit various control signals and information to the wireless power transmitter. Information transmitted by the wireless power receiver may include various state information items including reception power intensity information. In this case, the wireless power transmitter may calculate charging efficiency or power transmission efficiency based on reception power intensity information.

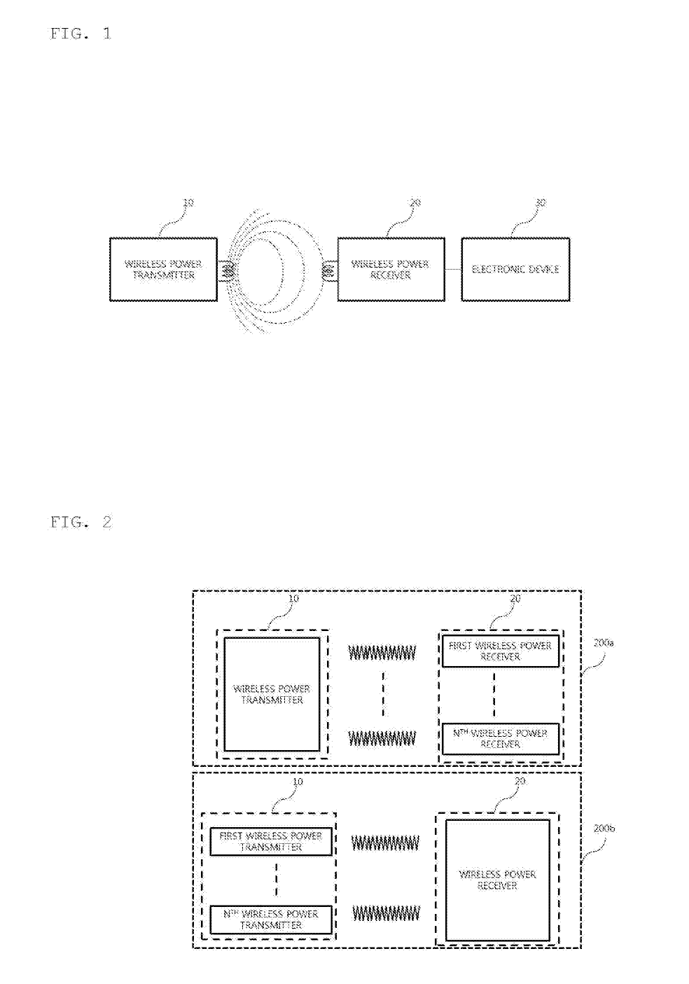

FIG. 1 is a block diagram for explanation of a wireless charging system according to an embodiment.

Referring to FIG. 1, the wireless charging system may broadly include a wireless power transmitter 10 for wirelessly transmitting power, a wireless power receiver 20 for receiving the transmitted power, and an electronic device 30 for supplying the received power.

For example, the wireless power transmitter 10 and the wireless power receiver 20 may perform in-band communication for exchanging information using the same frequency band as an operation frequency used in wireless power transmission. As another example, the wireless power transmitter 10 and the wireless power receiver 20 may also perform out-of-band communication for exchanging information using a separate different frequency band from the operation frequency used in wireless power transmission.

For example, the information exchanged between the wireless power transmitter 10 and the wireless power receiver may include control information as well as state information of each other. Here, the state information and the control information that are exchanged between the transmission and reception ends may be further obvious through the following descriptions of embodiments.

The in-band communication and the out-of-band communication may provide bi-directional communication, without being limited thereto, but, according to another embodiment, may provide unidirectional communication or half-duplex communication.

For example, the unidirectional communication refers to transmission of information only to the wireless power transmitter 10 from the wireless power receiver 20, without being limited thereto, but the wireless power transmitter 10 may also transmit information to the wireless power receiver 20.

In the half-duplex communication method, bi-directional communication is enabled between the wireless power receiver 20 and the wireless power transmitter 10, but only any one of the wireless power receiver 20 and the wireless power transmitter 10 is capable of transmitting information at any one time point.

The wireless power receiver 20 according to an embodiment may acquire various state information items of the electronic device 30. For example, the state information of the electronic device 30 may include current power usage information, information for identifying executed application, CPU usage information, battery charging state information, battery output voltage/current information, and so on, without being limited thereto, and may include any information that is capable of being acquired from the electronic device 30 and being used in wireless power control.

In particular, the wireless power transmitter 10 according to an embodiment may transmit a predetermined packet indicating whether high-speed charging is supported, to the wireless power receiver 20. When the wireless power transmitter 10 connected to the wireless power receiver 20 checks that a high-speed charging mode is supported, the wireless power receiver 20 may notify the electronic device about this. The electronic device 30 may display information indicating that high-speed charging is possible through a predetermined display device included therein, e.g., a liquid crystal display (LCD) device.

A user of the electronic device 30 may select a predetermined high-speed charging request button displayed on a LCD device to control the wireless power transmitter 10 to operate in a high-speed charging mode. In this case, when the high-speed charging request button is selected by the user, the electronic device 30 may transmit a predetermined high-speed charging request signal to the wireless power receiver 20. The wireless power receiver 20 may generate a charging mode packet corresponding the received high-speed charging request signal and may transmit the high-speed charging request signal to the wireless power transmitter 10, and thus, may transmit convert a general low-power charging mod into a high-speed charging mode.

FIG. 2 is a block diagram for explanation of a wireless charging system according to another embodiment.

For example, as shown in a reference numeral 200a, the wireless power receiver 20 may include a plurality of wireless power reception devices, and the plurality of wireless power reception devices may be connected to one wireless power transmitter 10 to perform wireless charging. In this case, the wireless power transmitter 10 may distribute and transmit power to the plurality of wireless power reception devices using a time-division method, but the present disclosure is not limited thereto, and as another example, the wireless power transmitter 10 may distribute and transmit power to a plurality of wireless power reception devices using different frequency bands allocated to respective wireless power reception devices.

In this case, the number of wireless power reception devices connectable to one wireless power transmitter 10 may be adaptively determined based on at least one of requested electric energy for respective wireless power reception devices, a battery charging state, power consumption of an electronic device, and available electric energy of a wireless power transmission device.

As another example, as shown in a reference numeral 200b, the wireless power transmitter 10 may include a plurality of wireless power transmission devices. In this case, the wireless power receiver 20 may be simultaneously be connected to the plurality of wireless power transmission devices, and may simultaneously receive power from the connected wireless power transmission devices to perform charging. In this case, the number of wireless power reception devices connectable to the wireless power receiver 20 may be adaptively determined based on requested electric energy of the wireless power receiver 20, a battery charging state, power consumption of an electronic device, available electric energy of a wireless power transmission device, and so on.

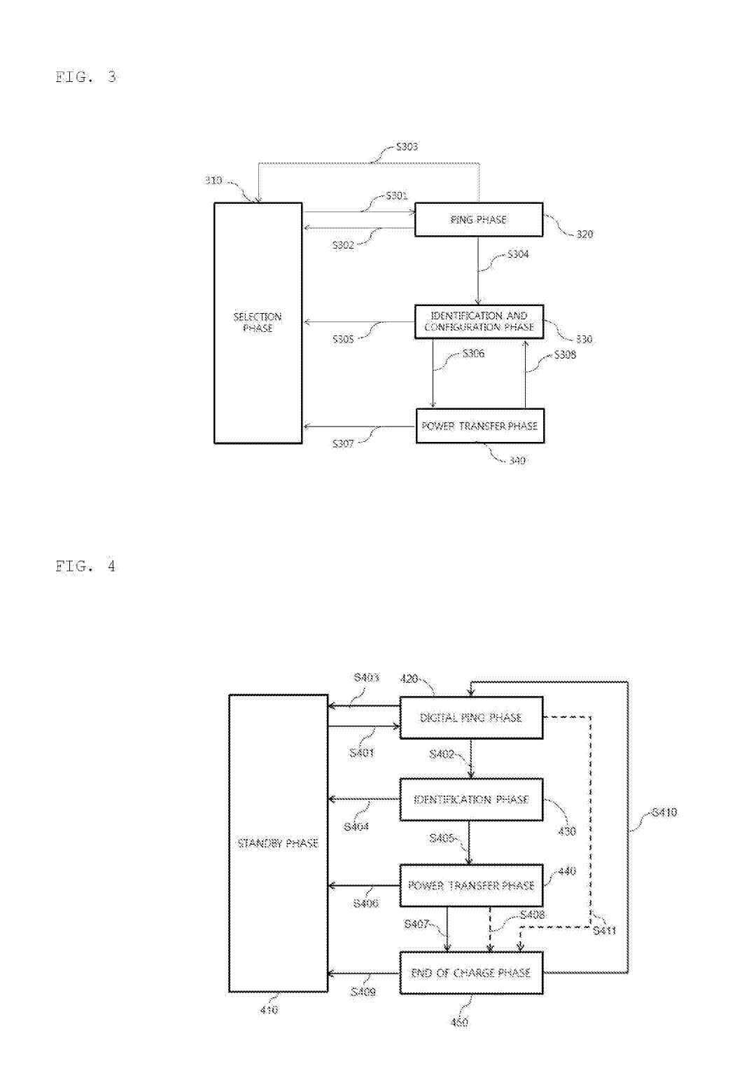

FIG. 3 is a state transition diagram for explanation of a wireless power transmission procedure defined in the wireless power consortium (WPC) standard.

Referring to FIG. 3, power transmission to a receiver from a transmitter according to the WPC standard may be broadly classified into a selection phase 310, a ping phase 320, an identification and configuration phase 330, and a power transfer phase 340.

The selection phase 310 may be a phase that transitions when a specific error or a specific event is detected while power transmissions is started or power transmission is maintained. Here, the specific error and the specific event would be obvious from the following description. In addition, in the selection phase 310, the transmitter may monitor whether an object is present on an interface surface. Upon detecting that the object is present on the interface surface, the transmitter may transition to the ping phase 320 (S301). In the selection phase 310, the transmitter may transmit an analog ping signal with a very short pulse and may detect whether an object is present in an activate area of the interface surface based on a current change of a transmission coil.

In the ping phase 320, upon detecting the object, the transmitter may activate the receiver and may transmit a digital ping for identifying whether the receiver is compatible with the WPC standard. In the ping phase 320, when the transmitter does not receive a response signal to the digital ping, e.g., a signal strength indicator from the receiver, the ping phase 320 may re-transition to the selection phase 310 (S302). In the ping phase 320, upon receiving a signal indicating that power transmission is completed, i.e., an end of power signal, from the receiver, the transmitter may transition to the selection phase 310 (S303).

When the ping phase 320 is completed, the transmitter may transition to the identification and configuration phase 330 for collecting receiver identification and receiver configuration and state information (S304).

In the identification and configuration phase 330, when the transmitter receives an unexpected packet or does not receive an expected packet for a predefined time period (time out), there is packet transmission error, or power transfer contract is not set, the transmitter may transition to the selection phase 310 (S305).

When identification and configuration of the receiver are completed, the transmitter may transition to the power transfer phase 340 for wirelessly transmitting power (S306).

In the power transfer phase 340, when the transmitter receives an unexpected packet or does not receive an expected packet for a predefined time period (time out), preset power transfer contract violation occurs, or charging is completed, the transmitter may transition to the selection phase 310 (S307).

In the power transfer phase 340, when power transfer contract needs to be re-configured depending on a state change in the transmitter, the transmitter may transition to the identification and configuration phase 330 (S308).

The power transfer contract may be set based on state and characteristics information of the transmitter and the receiver. For example, the state information of the transmitter may include information on a maximum transmissible power amount, information on the number of maximum acceptable receivers, and so on and the state information of the receiver may include information on required power, and so on.

FIG. 4 is a state transition diagram for explanation of a wireless power transmission procedure defined in the power matters alliance (PMA) standard.

Referring to FIG. 4, power transmission to a receiver from a transmitter according to the PMA standard may be broadly classified into a standby phase 410, a digital ping phase 420, an identification phase 430, a power transfer phase 440, and an end of charge phase 450.

The standby phase 410 may be a phase that transitions when a specific error or a specific event is detected while a receiver identification procedure for power transmission is performed or power transmission is maintained. Here, the specific error and the specific event would be obvious from the following description. In addition, in the standby phase 410, the transmitter may monitor whether an object is present on a charging surface. When the transmitter detects that the object is present on the charging surface or is performing RXID reattempt, the standby phase 410 may transition to the digital ping phase 420 (S401). Here, RXID refers to a unique identifier (ID) allocated to a PMA compatible receiver. In the standby phase 410, the transmitter may transmit an analog ping with a very short pulse and may detect whether an object is present in an active area of an interface surface, e.g., a charging bed based on a current change of a transmission coil.

The transmitter that transitions to the digital ping phase 420 may emit a digital ping signal for identifying whether the detected object is a PMA compatible receiver. When sufficient power is supplied to a receiver according to the digital ping signal transmitted by the transmitter, the receiver may modulate the received digital ping signal according to a PMA communication protocol to transmit a predetermined response signal to a transmitter. Here, the response signal may include a signal strength indicator indicating intensity of power received by the receiver. In the digital ping phase 420, upon receiving an effective response signal, the receiver may transition to the identification phase 430 (S402).

When, in the digital ping phase 420, the transmitter does not receive the response signal or the corresponding receiver is not a PMA compatible receiver, i.e., in the case of foreign object detection (POD), the transmitter may transition to the standby phase 410 (S403). For example, a foreign object (FO) may be a metallic object including a coin, a key, or the like.

In the identification phase 430, when the transmitter fails in a receiver identification procedure or needs to re-perform the receiver identification procedure and does not complete the receiver identification procedure within a predefined time period, the transmitter may transition to the standby phase 410 (S404).

Upon succeeding in receiver identification, the transmitter may transition to the power transfer phase 440 from the identification phase 430 and may initiate charging (S405).

In the power transfer phase 440, when the transmitter does not receive a desired signal within a predetermined time period (Time Out) or detects an FO, or a voltage of a reception coil is greater than a predefined reference value, the transmitter may transition to the standby phase 410 (S406).

In the power transfer phase 440, when temperature detected by a temperature sensor included in the transmitter is greater than a predetermined reference value, the transmitter may transition to the end of charge end 450 (S407).

In the end of charge end 450, upon checking that the receiver is removed from the charging surface, the transmitter may transition to the standby phase 410 (S409).

In an over-temperature state, when measured temperature is lowered to a reference value or less after a predetermined time period elapses, the transmitter may transition to the digital ping phase 420 from the end of charge end 450 (S410).

In the digital ping phase 420 or the power transfer phase 440, upon receiving an end of charge (FOC) request, the transmitter may transition to the end of charge end 450 (S408 and S411).

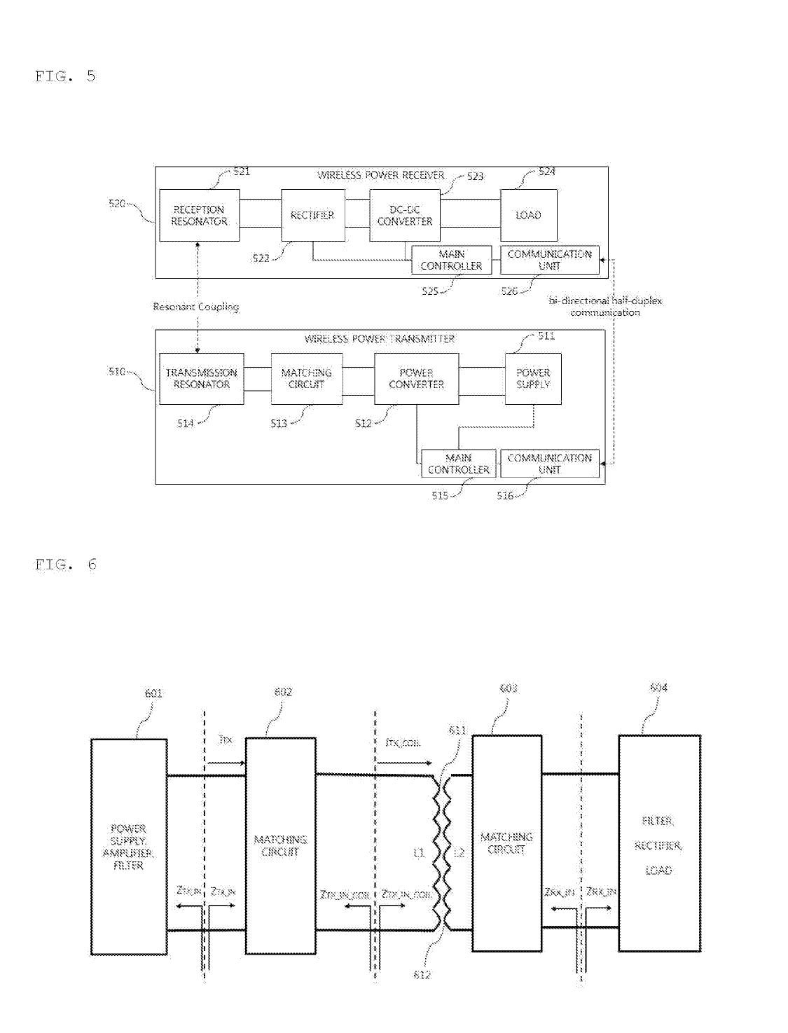

FIG. 5 is a block diagram for explanation of a structure of a wireless power transmission system according to an embodiment.

Referring to FIG. 5, the wireless power transmission system may include a wireless power transmitter 510 and a wireless power receiver 520.

Although FIG. 5 illustrates the case in which the wireless power transmitter 510 wirelessly transmits power to one wireless power receiver 520, this is merely an embodiment and, thus, according to another embodiment, the wireless power transmitter 510 may wirelessly transmit power to a plurality of wireless power receivers 520. It is noted that, according to another embodiment, the wireless power receiver 520 may wirelessly and simultaneously receive power from a plurality of wireless power transmitters 510.

The wireless power transmitter 510 may generate a magnetic field using a specific power transmission frequency and transmit power to the wireless power receiver 520.

The wireless power receiver 520 may receive power in synchronization with the same frequency as a frequency used by the wireless power transmitter 510.

For example, a frequency used for power transmission may be a band of 6.78 MHz, without being limited thereto.

That is, power transmitted by the wireless power transmitter 510 may be transmitted to the wireless power receiver 520 that resonates with the wireless power transmitter 510.

A maximum number of wireless power receivers 520 capable of receiving power from one wireless power transmitter 510 may be determined based on a maximum transmission power level of the wireless power transmitter 510, a maximum power reception level of the wireless power receiver 520, and physical structures of the wireless power transmitter 510 and the wireless power receiver 520.

The wireless power transmitter 510 and the wireless power receiver 520 may perform bi-directional communication with a different frequency band from a frequency for wireless power transmission, i.e. a resonance frequency band. For example, the bi-directional communication may use a half-duplex Bluetooth low energy (BLE) communication protocol.

The wireless power transmitter 510 and the wireless power receiver 520 may exchange each other's characteristics and state information, i.e. power negotiation information through the bi-directional communication.

For example, the wireless power receiver 520 may transmit predetermined power reception state information for controlling a level of power received from the wireless power transmitter 510 to the wireless power transmitter 510 through bi-directional communication, and the wireless power transmitter 510 may dynamically control a transmitted power level based on the received power reception state information. As such, the wireless power transmitter 510 may optimize power transmission efficiency and may also perform a function of preventing a load from being damaged due to over voltage, a function of preventing unnecessary power from being wasted due to under voltage, and so on.

The wireless power transmitter 510 may perform a function of authenticating and identifying the wireless power receiver 520 through bi-directional communication, a function of identifying an incompatible apparatus or a non-rechargeable object, a function for identifying a valid load, and so on.

Hereinafter, a wireless power transmission procedure of a resonance mode will be described in more detail with reference to FIG. 5.

The wireless power transmitter 510 may include a power supply 511, a power converter 512, a matching circuit 513, a transmission resonator 514, a main controller 515, and a communication unit 516. The communication unit 516 may include a data transmitter and a data receiver.

The power supply 511 may apply a specific voltage to the power converter 512 under control of the main controller 515. In this case, the applied voltage may be a DC voltage or an AC voltage.

The power converter 512 may convert a voltage received from the power supply 511 into a specific voltage under control of the main controller 515. To this end, the power converter 512 may include at least one of a DC/DC convertor, an AC/DC convertor, and a power amplifier.

The matching circuit 513 may be a circuit for matching impedance between the power converter 512 and the transmission resonator 514 in order to maximize power transmission efficiency.

The transmission resonator 514 may wirelessly transmit power using a specific resonance frequency according to a voltage applied from the matching circuit 513.

The wireless power receiver 520 may include a reception resonator 521, a rectifier 522, a DC-DC converter 523, a load 524, a main controller 525, and a communication unit 526. The communication unit 526 may include a data transmitter and a data receiver.

The reception resonator 521 may receive power transmitted by the transmission resonator 514 through a resonance phenomenon.

The rectifier 522 may perform a function of converting an AC voltage applied from the reception resonator 521 into a DC voltage.

The DC-DC converter 523 may convert the rectified DC voltage into a specific DC voltage required by the load 524.

The load 524 may be an internal battery of a terminal including a wireless power receiver. The internal battery may store power in a battery with a specific DC voltage output from the DC-DC converter 523 as an input voltage.

The main controller 525 may control operations of the rectifier 522 and the DC-DC converter 523 or may generate the characteristics and state information of the wireless power receiver 520 and may control the communication unit 526 to transmit the characteristics and state information of the wireless power receiver 520 to the wireless power transmitter 510. For example, the main controller 525 may monitor output voltages and current intensity of the rectifier 522 and the DC-DC converter 523 and control operations of the rectifier 522 and the DC-DC converter 523.

Information on the monitored output voltages and current intensity may be transmitted to the wireless power transmitter 510 through the communication unit 526 in real time.

The main controller 525 may compare the rectified DC voltage with a predetermined reference voltage to determine whether a current state is an over-voltage state or an under-voltage state, and upon detecting a system error state as the determination result, the main controller 525 may transmit the detection result to the wireless power transmitter 510 through the communication unit 526.

Upon detecting a system error state, the main controller 525 may control operations of the rectifier 522 and the DC-DC converter 523 or control power supplied to the load 524 using a predetermined over current cutoff circuit including a switch and/or a Zener diode in order to prevent a load from being damaged.

Although FIG. 5 illustrates the case in which the main controller 515 or 525 and the communication unit 516 or 526 are configured as different modules, this is merely an embodiment and, thus, according to another embodiment, it is noted that the main controller 515 or 525 and the communication unit 516 or 526 may be configured as one module.

FIG. 6 is an equivalent circuit diagram of a wireless power transmission system according to an embodiment.

In detail, FIG. 6 illustrates an interface point in an equivalent circuit for measuring reference parameters to be described below.

Hereinafter, the meaning of reference parameters illustrated in FIG. 6 will be described briefly.

I_{TX} and I_{TX}_{_}_{COIL} may refer to root mean square (RMS) current supplied to a matching circuit (or matching network) 601 of the wireless power transmitter and RMS current supplied to a transmission resonator coil 602 of the wireless power transmitter, respectively.

Z_{TX}_{_}_{IN} and Z_{TX}_{_}_{IN}_{_}_{COIL} may refer to input impedance of a front end of the matching circuit 601 of the wireless power transmitter and input impedance of a rear end of the matching circuit 601 and a front end of the transmission resonator coil 602, respectively.

L1 and L2 may refer to an inductance value of the transmission resonator coil 602 and an inductance value of a reception resonator coil 603, respectively.

Z_{RX}_{_}_{IN} may refer to input impedance of a rear end of a matching circuit 604 of a wireless power receiver and a front end of a filter/rectifier/load 605.

According to an embodiment, a resonance frequency used in an operation of a wireless power transmission system may be 6.78 MHz±15 kHz.

In addition, a wireless power transmission system according to an embodiment may provide simultaneous charging, i.e. multi-charging, to a plurality of wireless power receivers, and in this case, even if a new wireless power receiver is added or a wireless power receiver is removed, a reception power variation amount of a maintained wireless power receiver may be controlled not to exceed a predetermined reference value or more. For example, a reception power variation amount may be, without being limited to, ±10%.

According to a condition for maintaining the reception power variation amount, a wireless power receiver that is added to a charging area or is removed may not overlap with an existing wireless power receiver.

When the matching circuit 604 of the wireless power receiver is connected to a rectifier, a real part of Z_{TX}_{_}_{IN} may have an inverse relationship with load resistance of a rectifier (hereinafter, referred to as R_{RECT}). That is, increase in R_{RECT} may reduce Z_{TX}_{_}_{IN} and reduction in R_{RECT} may increase Z_{Tx}_{_}_{IN}.

According to the present disclosure, resonator coupling efficiency may be a maximum power reception ratio calculated by dividing power transmitted to the load 604 from a reception resonator coil by power carried in a resonance frequency band by the transmission resonator coil 602. Resonator coupling efficiency between the wireless power transmitter and the wireless power receiver may be calculated when reference port impedance Z_{TX}_{_}_{IN} of a transmission resonator and a reference port impedance Z_{RX}_{_}_{IN} of a reception resonator are completely matched with each other.

FIG. 7 is a state transition diagram for explanation of a state transition procedure of a wireless power transmitter using an electromagnetic resonance mode according to an embodiment.

Referring to FIG. 7, a state of the wireless power transmitter may roughly include a configuration state 710, a power save state 720, a low power state 730, a power transfer state 740, a local fault state 750, and a latching fault state 760.

When power is supplied to a wireless power transmitter, the wireless power transmitter may transition to the configuration state 710. The wireless power transmitter may transition to the power save state 720 when a predetermined reset timer expires or an initialization procedure is completed in the configuration state 710.

In the power save state 720, the wireless power transmitter may generate a beacon sequence and transmit the beacon sequence through a resonance frequency band.

Here, the wireless power transmitter may perform control to enter the power save state 720 and to initiate the beacon sequence within a predetermined time. For example, the wireless power transmitter may perform control to initialize the beacon sequence within 50 ms after transition to the power save state 720, without being limited thereto.

In the power save state 720, the wireless power transmitter may periodically generate and transmit a first beacon sequence for detection of the wireless power receiver and may detect impedance variation of a reception resonator, i.e. load variation. Hereinafter, for convenience of description, a first beacon and a first beacon sequence will be referred to as a short beacon or a short beacon sequence, respectively.

In particular, the short beacon sequence may be repeatedly generated and transmitted with a predetermined time interval t_{CYCLE} for a short period t_{SHORT}_{_}_{BEACON} so as to save standby power of the wireless power transmitter before the wireless power receiver is detected. For example, t_{SHORT BEACON} may be set to 30 ms or less and t_{CYCLE} may be set to 250 ms±5 ms. In addition, current intensity of a short beacon may be a predetermined reference value or more and may be gradually increased for a predetermined time. For example, minimum current intensity of a short beacon may be set to be sufficiently high so as to detect a wireless power receiver of Category 2 or more.

According to the present disclosure, a wireless power transmitter may include a predetermined sensing element for detection of change in reactance and resistance by a reception resonator according to a short beacon.

In addition, in the power save state 720, the wireless power transmitter may periodically generate and transmit a second beacon sequence for supplying sufficient power required for booting and response of the wireless power receiver. Hereafter, for convenience of description, the second beacon and the second beacon sequence will be referred to as a long beacon and a long beacon sequence, respectively.

That is, when booting is completed through a second beacon sequence, the wireless power receiver may broadcast a predetermined response signal through an out-of-band communication channel.

In particular, the long beacon sequence may be generated and transmitted with a predetermined time interval t_{LONG}_{_}_{BEACON}_{_}_{PERIOD} for a relatively long period compared with a short beacon sequence in order to supply sufficient power required for booting of the wireless power receiver. For example, t_{LONG}_{_}_{BEACON} may be set to 105 ms+5 ms, t_{LONG}_{_}_{BEACON}_{_}_{PERIOD} may be set to 850 ms, and current intensity of a long beacon may be relatively high compared with current intensify of the short beacon. In addition, the long beacon may be maintained with power of predetermined intensity during a transmission period.

Then, the wireless power transmitter may be on standby to receive a predetermined response signal during a transmission period of the long beacon after detecting change in impedance of a reception resonator. Hereinafter, for convenience of description, the response signal will be referred to as an advertisement signal. Here, the wireless power receiver may broadcast the advertisement signal through a different out-of-band communication frequency band from a resonance frequency band.

For example, the advertisement signal may include at least one or any one of message identification information for identifying a message defined in a corresponding out-of-band communication standard, unique service or wireless power receiver identification information for identifying whether a wireless power receiver is a proper receiver or a compatible receiver to a corresponding wireless power transmitter, output power information of a wireless power receiver, information on rated voltage/current applied to a load, antenna gain information of a wireless power receiver, information for identifying a category of a wireless power receiver, authentication information of a wireless power receiver, information on whether an over voltage protection function is installed, and version information of software installed in a wireless power receiver.

Upon receiving an advertisement signal, the wireless power transmitter may transition to the low power state 730 from the power save state 720 and, then, may establish an out-of-band communication link with a wireless power receiver. Continuously, the wireless power transmitter may perform a registration procedure to a wireless power receiver through the established out-of-band communication link. For example, when out-of-band communication is Bluetooth low-power communication, the wireless power transmitter may perform Bluetooth pairing with the wireless power receiver and the transmitter and the receiver exchange at least one of state information, characteristics information, and control information with each other through the paired Bluetooth link.

When the wireless power transmitter transmits a predetermined control signal, i.e. a predetermined control signal for requesting a wireless power receiver to transmit power to a load, for initializing charging through out-of-band communication in the low power state 730 to the wireless power receiver, the wireless power transmitter may transition to the power transfer state 740 from the low power state 730.

When an out-of-band communication link establishment procedure or registration procedure is not normally completed in the low power state 730, the wireless power transmitter may transition to the power save state 720 from the low power state 730.

The wireless power transmitter may drive a separately divided link expiration timer for connection with each wireless power receiver and the wireless power receiver needs to transmit a predetermined message indicating that the receiver is present to the wireless power transmitter with a predetermined time before the link expiration timer expires. The link expiration timer may be reset whenever the message is received and an out-of-band communication link established between the wireless power receiver and the wireless power receiver may be maintained when the link expiration timer does not expire.

When all link expiration timers corresponding to out-of-band communication links established between a wireless power transmitter and at least one wireless power receiver expire in the low power state 730 or the power transfer state 740, the wireless power transmitter may transition to the power save state 720.

Upon receiving a valid advertisement signal from the wireless power receiver, the wireless power transmitter in the low power state 730 may drive a predetermined registration timer. In this case, when a registration timer expires, a wireless power transmitter in the low power state 730 may transition to the power save state 720. In this case, the wireless power transmitter may output a predetermined notification signal indicating registration failure through a notification display element, e.g. including an LED lamp, a display screen, and a beeper, included in the wireless power transmitter.

When all connected wireless power receivers are completely charged in the power transfer state 740, the wireless power transmitter may transition to the low power state 730.

In particular, the wireless power receiver may permit registration of a new wireless power receiver in the remaining states except for the configuration state 710, the local fault state 750, and the latching fault state 760.

In addition, the wireless power transmitter may dynamically control transmitted power based on state information received from the wireless power receiver in the power transfer state 740.

In this case, receiver state information transmitted to the wireless power transmitter from the wireless power receiver may include at least one of required power information, information on voltage and/or current measured at a rear end of a rectifier, charging state information, information for announcing over current, over voltage, and/or overheating states, and information indicating whether an element for shutting off or reducing power transmitted to a load is activated according to over current or over voltage. In this case, the receiver state information may be transmitted at a predetermined period or may be transmitted whenever a specific event occurs. In addition, the element for shutting off or reducing power transmitted to a load according over current or over voltage may be provided using at least one of an ON/OFF switch and a Zener diode.

According to another embodiment, the receiver state information transmitted to the wireless power transmitter from the wireless power receiver may further include at least one of information indicating that external power is connected to the wireless power receiver by wire and information indicating that an out-of-band communication mode is changed, e.g. near field communication (NFC) may be changed to Bluetooth low energy (BLE) communication.

According to another embodiment, a wireless power transmitter may adaptively determine intensity of power to be received for each wireless power receiver based on at least one of current available power of the wireless power transmitter, priority for each wireless power receiver, and the number of connected wireless power receivers. Here, the intensity of power to be transmitted for each wireless power receiver may be determined as a ratio for receiving power based on maximum power to be processed by a rectifier of a corresponding wireless power receiver.

Then, the wireless power transmitter may transmit a predetermined power adjustment command containing information on the determined power intensity to the corresponding wireless power receiver. In this case, the wireless power receiver may determine whether power is capable of being controlled in the power intensity determined by the wireless power transmitter and may transmit the determination result to the wireless power transmitter through a predetermined power adjustment response message.

According to another embodiment, the wireless power receiver may transmit predetermined receiver state information indicating whether wireless power adjustment is possible according to the power adjustment command of the wireless power transmitter prior to reception of the power adjustment command.

The power transfer state 740 may be any one of a first state 741, a second state 742, and a third state 743 according to a power reception state of a connected wireless power receiver.

For example, the first state 741 may refer to a state in which power reception states of all wireless power receivers connected to the wireless power transmitter are each a normal voltage state.

The second state 742 may refer to a state in which a power reception state of at least one wireless power receiver connected to the wireless power transmitter is a low voltage state and a wireless power receiver of a high voltage state is not present.

The third state 743 may refer to a state in which a power reception state of at least one wireless power receiver connected to the wireless power transmitter is a high voltage state.

Upon detecting system error in the power save state 720, the low power state 730, or the power transfer state 740, the wireless power transmitter may transition to the latching fault state 760.

Upon determining that all connected wireless power receivers are removed from a charging region, the wireless power transmitter in the latching fault state 760 may transition to the configuration state 710 or the power save state 720.

In addition, upon detecting local fault in the latching fault state 760, the wireless power transmitter may transition to the local fault state 750. Here, when local fault is released, the wireless power transmitter in the local fault state 750 may re-transition to the latching fault state 760.

On the other hand, when the wireless power transmitter transitions to the local fault state 750 from any one of the configuration state 710, the power save state 720, the low power state 730, and the power transfer state 740, if local fault is released, the wireless power transmitter may transition to the configuration state 710.

When the wireless power transmitter transitions to the local fault state 750, power supplied to the wireless power transmitter may be shut off. For example, upon detecting fault such as over voltage, over current, and overheating, the wireless power transmitter may transition to the local fault state 750, without being limited thereto.

For example, upon detecting over voltage, over current, overheating, or the like, the wireless power transmitter may transmit a predetermined power adjustment command for reducing intensity of power received by the wireless power receiver to at least one connected wireless power receiver.

As another example, upon detecting over voltage, over current, overheating, or the like, the wireless power transmitter may transmit a predetermined control command for stopping charging of the wireless power receiver to at least one connected wireless power receiver.

Through the aforementioned power adjustment procedure, the wireless power transmitter may prevent a device from being damaged due to over voltage, over current, overheating, or the like.

When intensity of output current of a transmission resonator is a reference value or more, the wireless power transmitter may transition to the latching fault state 760. In this case, the wireless power transmitter having transitioned to the latching fault state 760 may attempt to adjust the intensity of the output current of the transmission resonator to a reference value or less for a predetermined time. Here, the attempt may be repeatedly performed a predetermined number of times. Despite repeated performance, when the latching fault state 760 is not released, the wireless power transmitter may transmit a predetermined notification signal indicating that the latching fault state 760 is not released, to a user using a predetermined notification element. In this case, when all wireless power receivers positioned in the charging region of the wireless power transmitter are removed by the user, the latching fault state 760 may be released.

On the other hand, when intensity of output current of a transmission resonator is reduced to a reference value or less within a predetermined time or the intensity of output current of the transmission resonator is reduced to a reference value or less during the predetermined repeated performance, the latching fault state 760 may be automatically released, and in this case, the wireless power transmitter may automatically transition to the power save state 720 from the latching fault state 760 and may re-perform detection and identification procedures on the wireless power receiver.

The wireless power transmitter in the power transfer state 740 may transmit consecutive power and may adaptively control the transmitted power based on state information of the wireless power receiver and a predefined optimal voltage region setting parameter.

For example, the optimal voltage region setting parameter may include at least one of a parameter for identifying a low voltage region, a parameter for identifying an optimal voltage region, a parameter for identifying a high voltage region, and a parameter for identifying an over voltage region.

When a power reception state of the wireless power receiver is in a low voltage region, the wireless power transmitter may increase transmitted power, and when the power reception state is in a high voltage region, the wireless power transmitter may reduce transmitted power.

The wireless power transmitter may control transmitted power to maximize power transmission efficiency.

The wireless power transmitter may control transmitted power such that a deviation of a power amount required by the wireless power receiver is a reference value or less.

In addition, when an output voltage of a rectifier of a wireless power receiver reaches a predetermined over voltage region, i.e. when an over voltage is detected, the wireless power transmitter may stop power transmission.

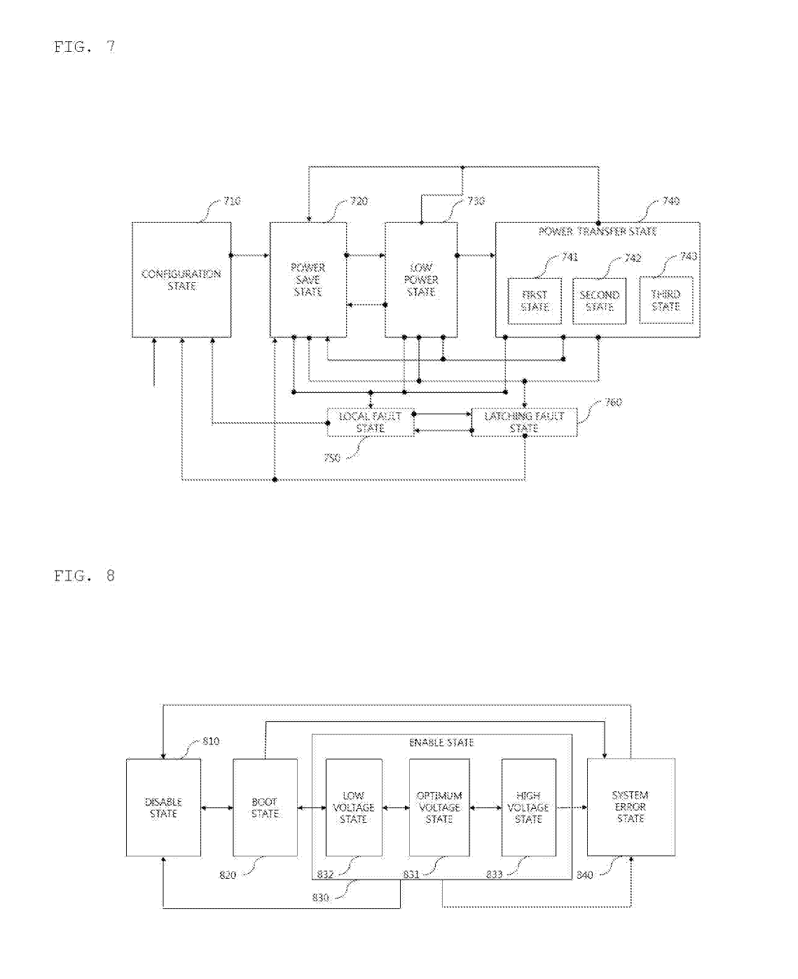

FIG. 8 is a state transition diagram of a wireless power receiver using an electromagnetic resonance mode according to an embodiment.

Referring to FIG. 8, a state of the wireless power receiver may largely include a disable state 810, a boot state 820, an enable state 830 (or an on state), and a system error state 840.

In this case, the state of the wireless power receiver may be determined based on intensity (hereinafter, for convenience of description, referred to as V_{RECT}) of an output voltage at an end of a rectifier of the wireless power receiver.

The enable state 830 may be divided into an optimum voltage state 831, a low voltage state 832, and a high voltage state 833 according to a value of V_{RECT}.

When a measured value of V_{RECT} is equal to or greater than a predetermined value of V_{RECT}_{_}_{BOOT}, the wireless power receiver in the disable state 810 may transition to the boot state 820.

In the boot state 820, the wireless power receiver may establish an out-of-band communication link with the wireless power transmitter and may stand by until a value of V_{RECT} reaches power required at an end of a load.

Upon checking that the value of V_{RECT} reaches power required at the end of the load, the wireless power receiver in the boot state 820 may transition to the enable state 830 and may begin charging.

Upon checking that charging is completed or stopped, the wireless power receiver in the enable state 830 may transition to the boot state 820.

Upon detecting predetermined system error, the wireless power receiver in the enable state 830 may transition to the system error state 840. Here, the system error may include other predefined system error conditions as well as over voltage, over current, and overheating.

When a value of V_{RECT} is reduced to a value of V_{RECT BOOT} or less, the wireless power receiver in the enable state 830 may transition to the disable state 810.

In addition, when a value of V_{RECT} is reduced to a value of V_{RECT}_{_}_{BOOT} or less, the wireless power receiver in the boot state 820 or the system error state 840 may transition to the disable state 810.

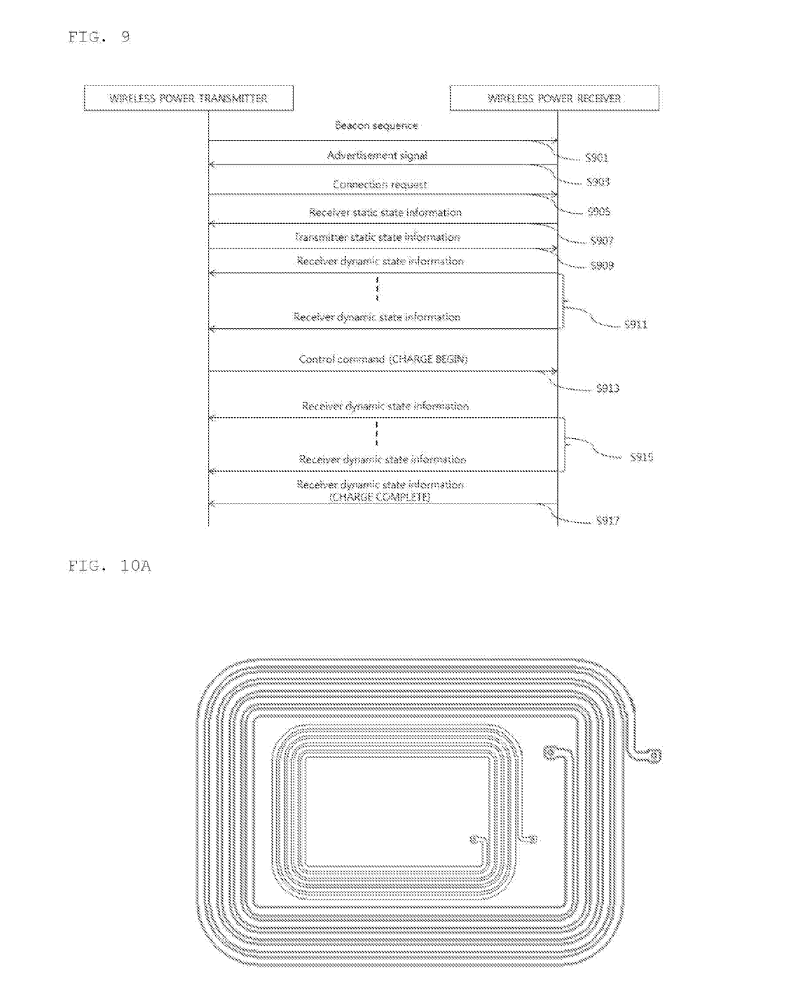

FIG. 9 is a flowchart for explanation of a wireless charging procedure using an electromagnetic resonance mode according to an embodiment.

Referring to FIG. 9, when configuration of the wireless power transmitter, i.e., booting is completed according to power supply, the wireless power transmitter may generate a beacon sequence and transmit the beacon sequence through a transmission resonator (S901).

Upon detecting the beacon sequence, the wireless power receiver may broadcast an advertisement signal containing identification information and characteristics information of the wireless power receiver (S903). In this case, it is noted that the advertisement signal may be repeatedly transmitted at a predetermined period until a connection request signal to be described later is received from the wireless power transmitter.

Upon receiving an advertisement signal, the wireless power transmitter may transmit a predetermined connection request signal for establishment of an out-of-band communication link to the wireless power receiver (S905).

Upon receiving the connection request signal, the wireless power receiver may establish the out-of-band communication link and transmit static state information of the wireless power receiver through the established out-of-band communication link (S907).

Here, the static state information of the wireless power receiver may include at least one of category information, hardware and software version information, maximum rectifier output power information, initial reference parameter information for power adjustment, information on required voltage or power, information for identifying whether a power adjustment function is installed, information on a supportable out-of-band communication mode, information on a supportable power control algorithm, and information on an initially set voltage value of an end of a preferred rectifier in a wireless power receiver.

Upon receiving the static state information of the wireless power receiver, the wireless power transmitter may transmit the static state information of the wireless power transmitter to the wireless power receiver through the out-of-band communication link (S909).

Here, the static state information of the wireless power transmitter may include at least one of transmitter power information, class information, hardware and software version information, information on a maximum number of supportable wireless power receivers, and/or a number of currently connected wireless power receivers.

Then, the wireless power receiver may monitor power reception state and charging state of the wireless power receiver in real time and may transmit dynamic state information to the wireless power transmitter periodically or when a specific event occurs (S911).

Here, the dynamic state information of the wireless power receiver may include at least one of information on output voltage and current of a rectifier, information on voltage and current applied to a load, information on an internally measured temperature of the wireless power receiver, reference parameter variation information (a minimum rectifying voltage value, a maximum rectifying voltage value, and initially set variation value in voltage at an end of a preferred rectifier) for power adjustment, charging state information, system error information, and alert information. The wireless power transmitter may change a setting value contained in existing static state information upon receiving the reference parameter variation information for power adjustment and perform power adjustment.

Upon preparing a sufficient amount of power for charging the wireless power receiver, the wireless power transmitter may transmit a predetermined control command through an out-of-band communication link and control the wireless power receiver to initiate charging (S913).

Then, the wireless power transmitter may receive dynamic state information from the wireless power receiver and may dynamically control transmitted power (S915).

When internal system error is detected or charging is completed, the wireless power receiver may add data for identifying corresponding system error and/or data indicating that charging is completed to the dynamic state information and transmit the information to the wireless power transmitter (S917). Here, the system error may include over current, over voltage, overheating, etc.

For example, an out-of-band communication mode applicable to embodiments of the present disclosure may include at least one of near field communication (NFC), radio frequency identification (RFID) communication, Bluetooth low energy (BLE) communication, wideband code division multiple access (WCDMA) communication, long term evolution (LTE)/LTE-advance communication, and Wi-Fi communication.

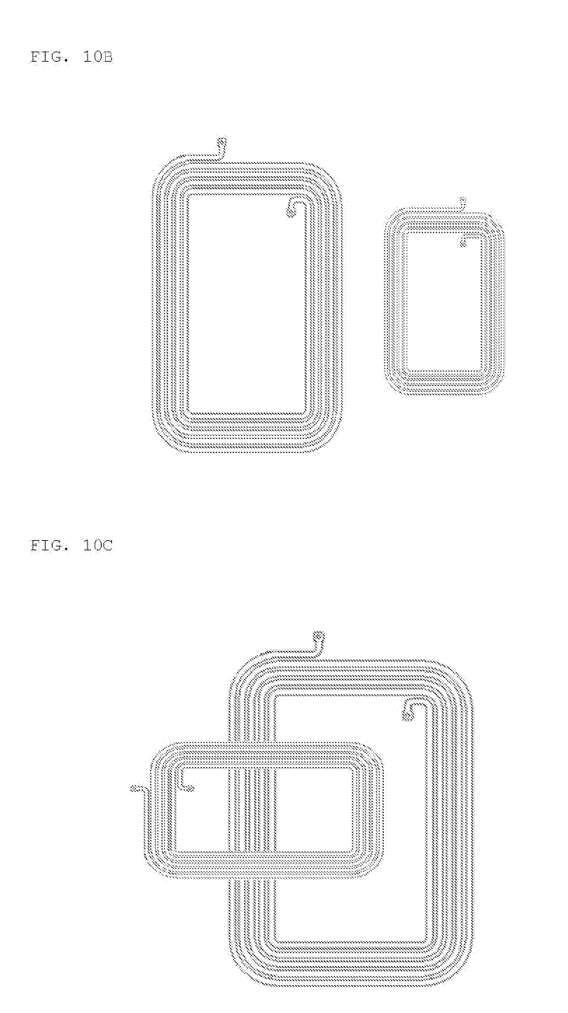

FIGS. 10A, 10B, and 100 are diagrams for explanation of an NFC antenna that is disposed adjacently to a wireless charging coil according to an embodiment.

Referring to FIGS. 10A, 10B, and 100, the NFC antenna and a wireless power antenna may be disposed adjacently to each other.

According to the present disclosure, the wireless power antenna is not limited to a wireless power transmission method. In other words, the wireless power antenna may receive power using at least one of an electromagnetic induction method, an electromagnetic resonance method, a radio frequency (RF) wireless power transmission method, or other wireless power transmission methods.

The wireless power antenna according to the present disclosure is not limited to various wireless power transmission standards that apply the same wireless power transmission method. In other words, the wireless power antenna that receives power using the electromagnetic induction method may receive power according to at least one standard of wireless power consortium (WPC) and/or power matters alliance (PMA). The wireless power antenna that receives power using the electromagnetic resonance method may receive power using a resonance method defined in the alliance for the wireless power (A4WP) standard organization.

As shown in FIG. 10A, the NFC antenna may be disposed within the wireless power antenna at the same plane level. In addition, depending on a size of an antenna, the NFC antenna may be disposed outside the wireless power antenna at the same plane level.

As shown in FIG. 10B, the NFC antenna may be disposed adjacently to right and left sides at the same plane level as the wireless power antenna, or as shown in FIG. 10C, the NFC antenna and the wireless power antenna may be disposed to partially overlap with each other.

The present disclosure is obtained from the fact that the NFC antenna receives power according to a magnetic field, a power signal, or an RF signal, for wireless power transmission. Accordingly, embodiments may include any arrangement in which an NFC antenna is positioned in a region that receives power from a wireless power transmitter in relation to an arrangement of an NFC antenna and a wireless power antenna.

That is, embodiments may also include any arrangement as long as an NFC antenna is affected by wireless power transmission (e.g., power signal or power control signal) due to arrangement in which the NFC antenna and the wireless power antenna are disposed adjacently to each other.

In particular, when wireless power transmission is high-speed charging (e.g., when output voltage is 9 V and output current is 1.67 A) other than general charging (e.g., when output voltage is 5 V and output current is 2 A), a distance between an NFC antenna and a wireless power antenna may be reduced, the distance between the NFC antenna and the wireless power antenna according to the embodiments may not be limited.

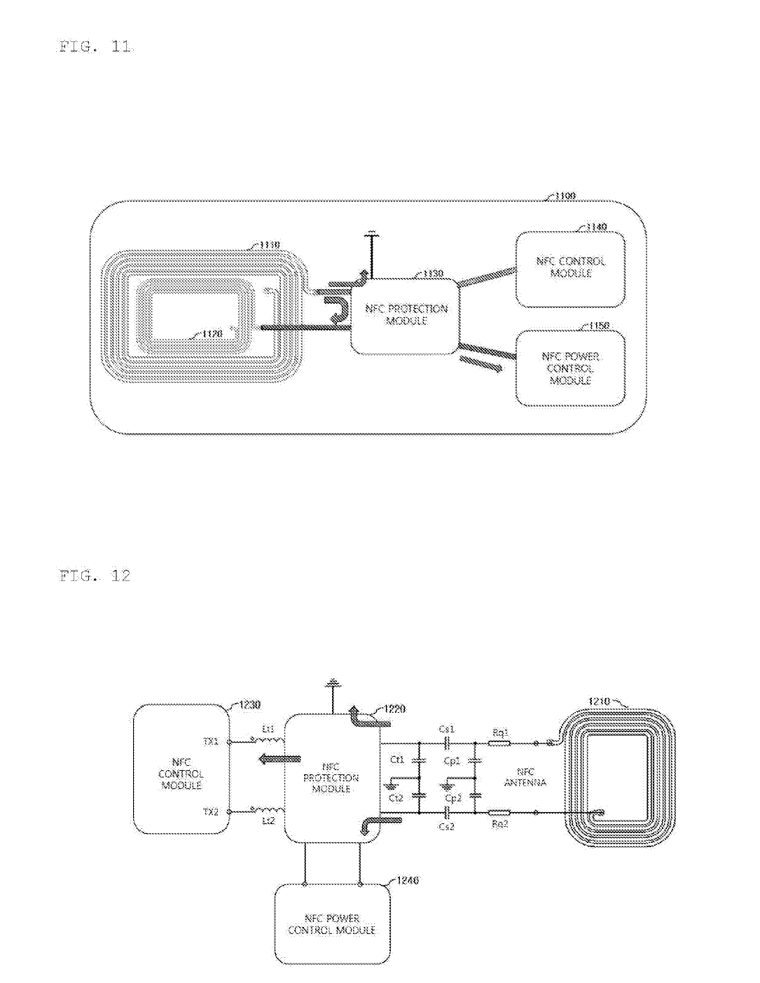

FIG. 11 is a diagram for explanation of the configuration of a wireless power receiver including an NFC antenna according to an embodiment.

Referring to FIG. 11, a wireless power receiver 1100 may include an NFC antenna 1110, a wireless power antenna 1120, an NFC protection module 1130, an NFC control module 1140, and a wireless power control module 1150. The components shown in FIG. 11 are not necessary, and thus, greater or fewer components than in FIG. 11 may also constitute a wireless power receiver.

Each NFC device for executing a peer to peer (P2P) mode may function as an NFC initiator and an NFC target.

NFC communication may be an embodiment that is a type of radio frequency identification (RFID) technology that uses a frequency band of 13.56 MHz and is capable of performing bidirectional communication between NFC devices, and a short-distance wireless communication technology installed in a wireless power transceiver to transmit power and a signal. NFC communication may support bidirectional transmission and reception of data at a distance within 10 cm.

NFC communication may be divided into a card mode, an RFID reader mode, and a P2P mode according to an operation mode. NFC communication may provide various mobile payment methods such as transportation card and discount coupon based on non-contact type smart card technology and security, may enable website access and information acquisition using a smart poster, or the like to which an RFID tag is attached as well as an NFC device in an RFID reader mode, and each NFC device may operate to transmit and receive data to and from each other and to share files with each other in a P2P mode that is a bidirectional communication mode.

Each NFC device may exchange bidirectional information in a P2P mode. In the P2P mode, generally, a logical link control protocol (LLCP) may be used to establish, activate, deactivate, and manage a data link.

NFC communication is performed by an NFC device including an NFC tag installed therein. In detail, a magnetic field is changed between a first NFC device including an NFC tag and an NFC coil antenna (hereinafter, referred to as “NFC antenna”) and an NFC coil antenna included in another second NFC device, and simultaneously, current is generated due to electromagnetic induction phenomenon to perform NFC communication. That is, while the magnetic field is changed between NFC coil antennas, current is generated due to electromagnetic induction phenomenon, and communication between devices is performed using the current.

NFC communication may be divided in an active mode for communication between readers and a passive mode for communication between a reader and a tag.

In the active mode, each NFC device may be divided into an NFC initiator functioning as a reader and an NFC target functioning as a tag according to functions.

The NFC initiator may provide a carrier electromagnetic field to the NFC target, and the NFC target may respond by modulating a current electromagnetic field. The NFC target operates by receiving power according to an electromagnetic field provided by the NFC initiator, and thus, is also referred to as a transponder. That is, the NFC initiator may selectively transmit an NFC signal with driving power of the NFC target. Both the NFC initiator and the NFC target that are differentiated according to functions may also function as a power supply, and may selectively generate an electromagnetic field to perform communication. When any one of the NFC initiator and the NFC target receives data, the corresponding one may deactivate a high-frequency electromagnetic field to operate as an NFC target.

According to an embodiment, a wireless power receiver may function as an NFC target, and the NFC antenna 1110 may receive an NFC signal from an NFC initiator.

The NFC antenna 1110 may be disposed adjacently to the wireless power antenna 1120 to receive a power signal.

The NFC protection module 1130 may monitor power generated by the NFC antenna 1110. The power (current or voltage) generated by the NFC antenna 1110 may be generated according to an NFC signal from the NFC initiator or may be generated according to a power signal from a wireless power transmitter.

According to an embodiment, the NFC protection module 1130 may monitor current or voltage generated by the NFC antenna 1110.

According to an embodiment, the NFC protection module 1130 may monitor the NFC antenna 1110 only during wireless power transmission. In other words, this corresponds to the case in which a wireless power transmitter enters a power transfer phase in an electromagnetic induction method or an electromagnetic resonance method, and the NFC protection module 1130 may monitor the NFC antenna 1110 only when a power signal has relatively high intensity. This is because power is generated by the NFC antenna 1110 due to a storing power signal.

In this regard, the wireless power control module 1150 may transmit a signal indicating entrance into a power transfer phase, to the NFC protection module 1130, and the NFC protection module 1130 may begin to monitor the NFC antenna 1110 from a time point of receiving the signal indicating entrance into the power transfer phase.

In addition, the NFC protection module 1130 may receive state information on power transfer from the wireless power control module 1150 to determine whether monitoring is performed.

When overpower with predetermined power or greater is generated by the NFC antenna 1110, the NFC protection module 1130 may block power supplied to the NFC control module 1140.

The NFC protection module 1130 may supply the blocked overpower to the wireless power control module 1150 or, when amplitude of overpower is greater than limited power of the wireless power control module 1150, the NFC protection module 1130 may discharge overpower.

When the NFC antenna 1110 performs general NFC communication of receiving an NFC signal, the NFC protection module 1130 may supply power (current or voltage) to the NFC control module 1140, but when overpower is generated from the NFC antenna, the NFC protection module 1130 may block the overpower from being supplied to the NFC control module 1140, and thus, may protect the NFC control module 1140.

The NFC control module 1140 may control and manage overall NFC communication, and the wireless power control module 1150 may control and manage overall wireless power reception.

FIG. 12 is a diagram for explanation of power transfer of an NFC protection module according to an embodiment.

Referring to FIG. 12, an NFC protection module 1220 may supply power in three directions indicated by arrows.

The NFC protection module 1220 may receive a request signal indicating whether monitoring of the NFC antenna 1210 is performed, from a wireless power control module 1240 or an NFC control module 1230.

Inductors Lₜ₁ and Lₜ₂ may be disposed between the NFC control module 1230 and the NFC protection module 1220.

The NFC protection module 1220 that receives the request may monitor power generated from the NFC antenna 1210.

The NFC protection module 1220 may monitor at least one of current or voltage as an index of power generated from the NFC antenna 1210.

According to an embodiment, as the monitoring result, when current intensity is greater than current intensity allowed by the NFC control module 1230, the NFC protection module 1220 may block the current supplied to the NFC control module 1230. In other words, the NFC protection module 1220 may supply only current equal to or less than maximum allowable current of the NFC control module 1230 to the NFC control module. For example, the NFC protection module 1220 may block the current when intensity of current generated by the NFC antenna 1210 is greater than 650 mA.

According to another embodiment, as the monitoring result, when intensity of the voltage generated by the NFC antenna 1210 is greater than intensity of allowable voltage of the NFC control module 1230, the NFC protection module 1220 may block the voltage applied to the NFC control module 1230.

The NFC protection module 1220 may convert a path of the blocked current or voltage into the wireless power control module 1240.

However, when intensity of the blocked current or voltage is greater than intensity of allowable current or voltage of the wireless power control module 1240, the NFC protection module 1220 may ground and discharge the blocked current or voltage to prevent a circuit of NFC control module 1230 and the wireless power control module 1240 from being damaged.

Resistors R_{q1} and R_{q2} and capacitors Cₜ₁, Cₜ₂, Cₛ₁, CS2, Cₚ₁, and Cₚ₂ may be disposed between the NFC antenna 1210 and the NFC protection module 1220.

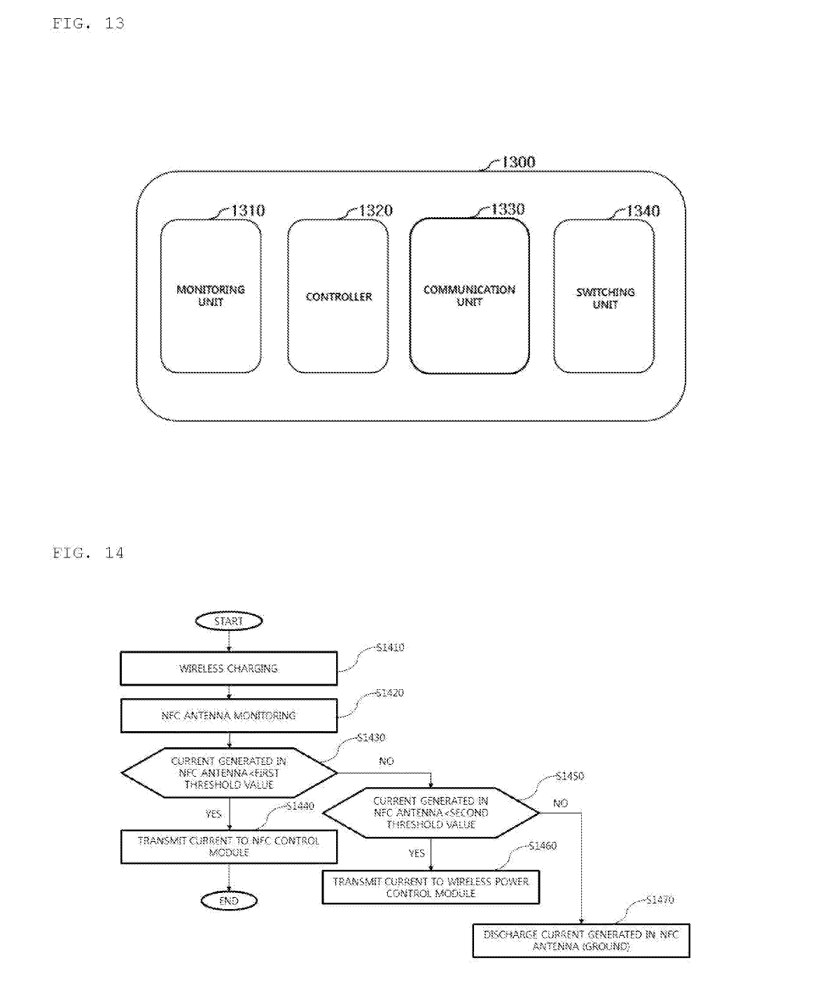

FIG. 13 is a diagram for explanation of the configuration of an NFC protection device according to an embodiment.

Referring to FIG. 13, an NFC protection device 1300 may include a monitoring unit 1310, a controller 1320, a communication unit 1330, and a switching unit 1340. The components shown in FIG. 13 are not necessary, and thus, greater or fewer components than in FIG. 13 may also constitute the NFC protection device 1300.

The monitoring unit 1310 may monitor power generated from the NFC antenna. The monitoring unit 1310 may directly monitor power generated from the NFC antenna, but may monitor at least one of current or voltage generated from the NFC antenna, as an index of power.

The monitoring unit 1310 may the monitoring result of the power generated from the NFC antenna to the controller 1320.

In general, a circuit may be damaged by current, and thus, the monitoring unit 1310 may monitor whether overcurrent is generated in the NFC antenna.

The controller 1320 may compare the monitoring result with allowable power (voltage or current) of the NFC control module or the wireless power control module.

According to an embodiment, a maximum value of allowable current of the NFC control module may be 650 mA and a maximum value of allowable voltage of the NFC control module may be 2.75 V. Maximum allowable current of the wireless power control module may be 2 A.

Accordingly, when overcurrent equal to or greater than 650 mA is generated in the NFC antenna, the controller 1320 may control the switching unit 1340 to block a path applied to the NFC control module. When overcurrent equal to or greater than 2 A is generated in the NFC antenna, the controller 1320 may control the switching unit 1340 to block and ground a path applied to the wireless power control module.

The communication unit 1330 may receive a request signal indicating whether monitoring of the NFC antenna is activated, from the NFC control module or the wireless power control module, and may receive charging state information of wireless power transmission from the wireless power control module.

The switching unit 1340 may include a plurality of switches for connecting (short-circuiting) or disconnecting (opening) a path for applying current or voltage.

According to the present disclosure, the switching unit 1340 may include switches of power supplied to the NFC antenna, which correspond to a first path connected to the NFC control module, a second path connected to a wireless power control module, and a third path connected to a ground for discharging, respectively.

FIG. 14 is a diagram for explanation of a control method for protecting an NFC control module according to an embodiment.

Referring to FIG. 14, in general, overpower is not generated in an NFC antenna during NFC communication, and thus, when the NFC protection module begins wireless charging, a control method for protecting the NFC control module may be performed (S1410).

The NFC protection module may receive information on wireless charging starting, from the wireless power control module. In addition, the NFC protection module may receive a request about whether monitoring is activated, from the wireless power control module or the NFC control module.

The NFC protection module may monitor the NFC antenna (S1420), and only when intensity of current generated in the NFC antenna is less than a first threshold value (path of “YES” of S1430), the NFC protection module may transmit current to the NFC control module (S1440).

The first threshold value may be a maximum allowable current value (e.g., 650 mA) of the NFC control module.

When intensity of the current generated in the NFC antenna is greater than the first threshold value (path of “NO” of S1430) and is less than a second threshold value (path of “YES” of S1450), the NFC protection module may transmit current to the wireless power control module.

The second threshold value may be greater than the first threshold value, and the second threshold value may be a maximum allowable current value (e.g., 2 A) of the wireless power control module.

When intensity of the current generated in the NFC antenna is greater than the second threshold value (path of “NO” of S1450), the NFC protection module may transmit the current to a ground for discharging (S1470).

The method according to the aforementioned embodiment may be prepared in a program to be executable in a computer and may be stored in a computer readable recording medium. Examples of the computer readable recording medium include read-only memory (ROM), random-access memory (RAM), CD-ROMs, magnetic tapes, floppy disks, optical data storage devices, etc. and may be realized in the form of a carrier wave (for example, transmission over the Internet).

The computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

Those skilled in the art will appreciate that the present disclosure may be carried out in other specific ways than those set forth herein without departing from the spirit and essential characteristics of the present disclosure.

It will be apparent to those skilled in the art that various modifications and variations can be made in the present disclosure without departing from the spirit or scope of the present disclosure. Thus, it is intended that the present disclosure cover the modifications and variations of the embodiment provided they come within the scope of the appended claims and their equivalents.

### INDUSTRIAL APPLICABILITY

A method of controlling a wireless power receiver according to an embodiment may used in a wireless power receiver for protecting a near field communication (NFC) control device from over current or overvoltage generated in an NFC antenna by a magnetic field or a radio frequency (RF) signal for wireless power transmission when the NFC antenna and the wireless power antenna are disposed adjacently to each other.

1-10. (canceled)

11. A method of controlling a wireless power receiver, the method comprising:
detecting power generated from a near field communication (NFC) antenna, by an NFC protection module;
when amplitude of the power satisfies a block condition, blocking power supplied to an NFC control module, by the NFC protection module; and
supplying the blocked power to a wireless power control module or discharging the power, by the NFC protection module.

12. The method of claim 11, wherein the detecting of the power includes detecting intensity of current or voltage generated from the NFC antenna.

13. The method of claim 12, wherein:
the block condition is satisfied when the intensity of the current is greater than a first threshold value;
the supplying the blocked power to the wireless power control module or discharging the power, by the NFC protection module includes, supplying the current to the wireless power control module when the intensity of the current is less than a second threshold value, and discharging the current when the intensity of the current is greater than the second threshold value; and
the second threshold value has a value greater than the first threshold value.

14. The method of claim 12, further comprising receiving a block signal about whether power is blocked, from the wireless power control module, by the NFC protection module, or receiving charging state information from the wireless power control module to determine whether power is blocked, by the NFC protection module.

15. The method of claim 13, wherein the supplying the blocked power to the wireless power control module or discharging the power, by the NFC protection module includes supplying the current to a wireless power antenna or supplying the current to a wireless power rectifier configured to receive current from the wireless power antenna.

16. The method of claim 12, wherein:
the block control is satisfied when the intensity of the voltage is greater than a first threshold value;
the supplying the blocked power to the wireless power control module or discharging the power, by the NFC protection module includes, applying the voltage to the wireless power control module when the intensity of the voltage is less than a second threshold value, and discharging the voltage when the intensity of the voltage is greater than the second threshold value; and
the second threshold value has a value greater than the first threshold value.

17. The method of claim 16, wherein the supplying the blocked power to the wireless power control module or discharging the power, by the NFC protection module includes supplying the voltage to the wireless power antenna or supplying the voltage to a wireless power rectifier configured to receive a voltage from the wireless power antenna.

18. A wireless power receiver comprising:
a near field communication (NFC) antenna;
a wireless power antenna;
an NFC control module configured to control NFC communication;
a wireless power control module configured to control wireless power received through the wireless power antenna; and
an NFC protection module configured to detect power generated from the NFC antenna, to block power supplied to the NFC control module when amplitude of the power satisfies a block condition, and to supply the blocked power to the wireless power control module or to discharge the power.

19. The wireless power receiver of claim 18, wherein the NFC protection module includes:
a monitoring unit configured to detect intensity of current generated from the NFC antenna; and
a communication unit configured to receive a block signal about whether power is blocked, from the wireless power control module.

20. The wireless power receiver of claim 19, wherein the block condition is satisfied when the intensity of the current is greater than a first threshold value.

21. The wireless power receiver of claim 19, wherein the NFC protection module includes a controller configured to receive charging state information from the wireless power control module to determine whether power is blocked or to determine whether power is blocked based on the block signal.

22. The wireless power receiver of claim 18, wherein NFC antenna is disposed adjacent to the wireless power antenna.

23. The wireless power receiver of claim 19, wherein:
the NFC protection module includes a switching unit configured to supply the current to the wireless power control module when the intensity of the current is less than a second threshold value, and to discharge the current when the intensity of the current is greater than the second threshold value; and
the second threshold value has a value greater than a first threshold value.

24. The wireless power receiver of claim 18, wherein the NFC protection module includes a monitoring unit configured to detect intensity of voltage generated from the NFC antenna.

25. The wireless power receiver of claim 24, wherein the block condition is satisfied when the intensity of the voltage is greater than a first threshold value.

26. The wireless power receiver of claim 25, wherein:
the NFC protection module includes a switching unit configured to apply the voltage to the wireless power control module when the intensity of the voltage is less than a second threshold value, and to discharge the voltage when the intensity of the voltage is greater than the second threshold value; and
the second threshold value has a value greater than the first threshold value.

27. A near field communication (NFC) protection device comprising:
a monitoring unit configured to detect power generated from an NFC antenna;
a controller configured to block power supplied to an NFC control module when amplitude of the power satisfies a block condition; and
a switching unit configured to supply the blocked power to a wireless power control module or to discharge the power,
wherein the NFC antenna is disposed adjacent to the wireless power antenna.

28. The NFC protection device of claim 27, wherein the monitoring unit detects intensity of current generated from the NFC antenna, and the block condition is satisfied when the intensity of the current is greater than a first threshold value.

29. The NFC protection device of claim 28, further comprising a communication unit configured to receive a block signal about whether power is blocked, from the wireless power control module,
wherein the controller determines whether power is blocked based on the block signal or charging state information received from the wireless power control module.

30. The NFC protection device of claim 28, wherein:
the switching unit supplies the current to the wireless power control module when the intensity of the current is less than a second threshold value, and discharges the current when the intensity of the current is greater than the second threshold value; and
the second threshold has a value greater than the first threshold value.
